(19) United States
(12) Patent Application Publication
(10) Pub. No.: US 2008/0217042 A1
(43) Pub. Date: Sep. 11, 2008

(54) METHOD FOR MAKING RAIL BONDS

(76) Inventors: Ward M. Judson, Hudson, OH (US); Matthew J. Flemming, Medina, OH (US)

Correspondence Address: Jonathan A. Platt;Renner, Otto, Boisselle & Sklar, LLP, 19th Floor, 1621 Euclid Ave., Cleveland, OH, 44115, US

(21) Appl. No.: 12/041,116

(22) Filed: Mar. 3, 2008

Related U.S. Application Data
(60) Provisional application No. 60/892,970, filed on Mar. 5, 2007.

(51) Int. Cl. B60M 5/00; H01R 11/11; H02G 15/22

(52) U.S. Cl. 174/19; 29/863; 228/44.7; 174/21 R

(57) ABSTRACT

A rail bond for bonding a wire or cable to a surface of rail includes a copper sheet and weld metal material solidified from molten metal material. A copper or other metal sheet is placed against the surface of the rail where the bond is to be located, and against an opening of a chamber of a graphite mold where the molten weld metal material is formed. Molten material is produced into liquid form and flows to the copper sheet material. This causes the copper sheet material to melt and bond against the steel rail. The presence of the copper sheet material between the molten weld metal and the rail surface reduces the amount of heating in the steel rail, and reduces the size of the heat affected zone (HAZ) in the steel rail.

This application claims priority under 35 USC 119 to U.S. Provisional Application No. 60/892,970, filed Mar. 5, 2007, which is incorporated herein by reference in its entirety.

### BACKGROUND OF THE INVENTION

1. Technical Field of the Invention

The invention relates to systems and methods for bonding cables or wires to rails.

2. Description of the Related Art

Electrical connections are made to rail for both signal (rail break detection, signal actuation, and detection of train presence) and power applications (high current). A longstanding type of rail connection uses exothermic welding to join a copper conductor to the rail steel. The connection must provide continuous low electrical resistance over a long service life (25+ years). To maintain a long service life, the connection must maintain adequate mechanical strength at the weld interface. One advantage of exothermic welding over other types of connections, including brazing and mechanical drilled-hole-and-pins, is the superior electrical interface between the rail steel and the conductor due to welding.

It will be appreciated that improvements in rail bonds would be desirable.

### SUMMARY OF THE INVENTION

According to an aspect of the invention, a method of making a weld material rail bond includes placing a copper sheet between a mold chamber where weld material is to be formed, and a rail or other object to be bonded to.

According to another aspect of the invention, a copper sheet, placed between a weld metal chamber and an object to be bonded to, has a variable thickness, being thicker at a portion that is more directly inline with the impinging molten weld metal material from the chamber.

According to yet another aspect of the invention, a method of forming a welded rail bond includes placing a meltable interposer material between the rail and the weld metal material, to reduce the amount of material in the rail that is affected by the heat of the bonding process.

According to still another aspect of the invention, a rail bond includes: weld metal; and a metal sheet attached to the conductor cable.

According to a further aspect of the invention, a method of bonding on a rail includes the steps of: placing a metal sheet against the rail; and bringing molten weld metal material into contact with the metal sheet, thereby causing the metal sheet to melt and bond with the rail.

According to a still further aspect of the invention, a method of bonding on a rail includes the steps of: placing a cable, wire, or rod into a chamber of a mold; placing a metal sheet in an opening in the mold, adjacent to the chamber; placing the mold against the rail, with the metal sheet between the rail and the cable, wire, or rod; and directing molten metal material into the chamber, thereby causing the metal sheet to melt and bond with the rail.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an oblique view of a rail bond system in accordance with an embodiment of the present invention;

FIG. 2 is an oblique view of a sheet of the rail bond system of FIG. 1;

FIG. 3 is an oblique view of the sheet of FIG. 2 coupled to a wire to be bonded to a rail;

FIG. 4 is an oblique view of a sleeve connection with a cable, in accordance with an embodiment of the present invention;

FIG. 5 is an oblique view of the connection of FIG. 4, with the sleeve flattened;

FIG. 6 is an oblique view of a two-sheet connection between with a cable, in accordance with an embodiment of the present invention;

FIG. 7 is an oblique of a crimped sleeve connection between a cable and a copper sheet, in accordance with an embodiment of the present invention;

FIG. 8 is a cross-sectional view of part of the rail bond system of FIG. 1, showing depth of a heat affected zone (HAZ) of the rail;

FIG. 9 is a mold used in forming the rail bond of FIG. 1; and

FIG. 10 is a high-level flowchart of steps involved in making the rail bond of FIG. 1.

### DETAILED DESCRIPTION

A rail bond for bonding a wire, rod, or cable to a surface of rail includes a metal sheet, such as a copper sheet, and weld metal material solidified from molten metal material. A copper or other metal sheet is placed against the surface of the rail where the bond is to be located, and against an opening of a chamber of a graphite mold where the molten weld metal material is formed. Molten material is produced into liquid form and flows to the copper sheet material. This causes the copper sheet material to melt and bond against the steel rail. The presence of the copper sheet material between the molten weld metal and the rail surface reduces the amount of heating in the steel rail, and reduces the size of the heat affected zone (HAZ) in the steel rail. By reducing heating in the steel rail, a region of structure changes in the steel rail material may be at least reduced in extent. The resulting rail bond is a high strength bond having a smaller HAZ than weld metal bonds where the weld metal is placed in direct contact with the surface of the steel rail.

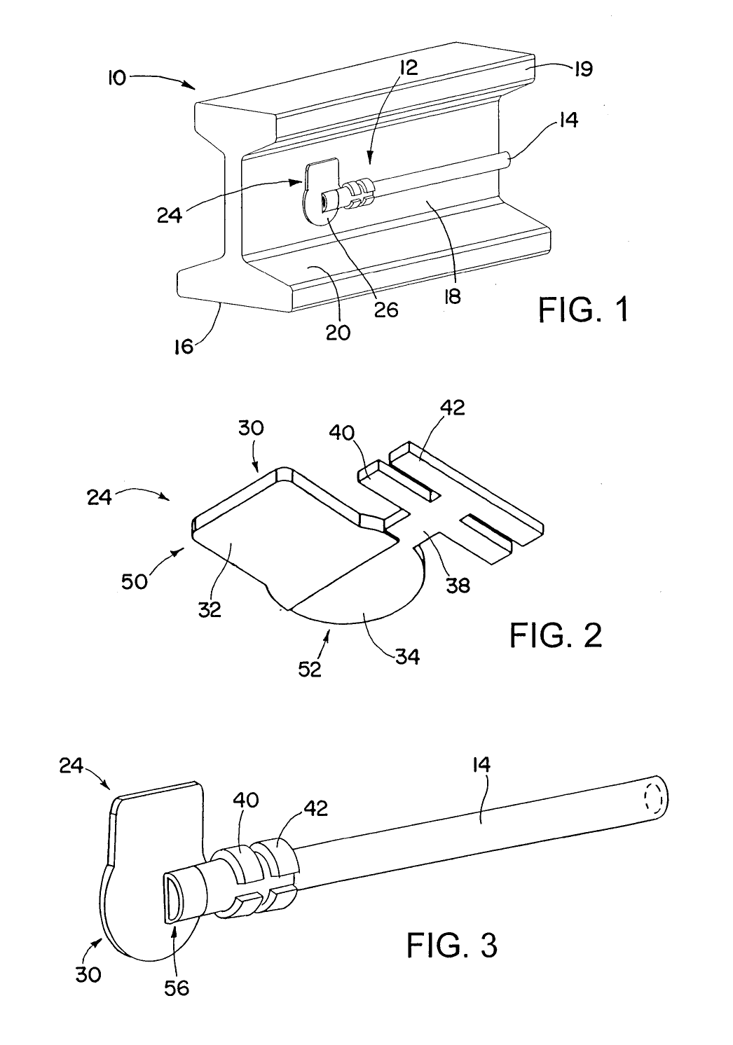

Referring initially to FIG. 1, a rail bond system 10 includes a rail bond 12 for bonding a wire or cable 14 to a rail 16. As illustrated in FIG. 1, the bond 12 may be located on a web surface 18 of the rail 16. Alternatively, the wire 14 may be bonded with the rail bond 12 to a head 19 or a base 20 of the rail 16.

The rail bond 12 includes a metal sheet 24, such as a copper sheet, in contact with the web surface 18. The rail bond 12 also includes solidified weld metal material 26. The weld metal material 26 may be formed by an exothermic reaction of a reductant metal and a suitable reactant, such as a transition metal oxide. Examples are reactions of aluminum powder and copper oxide powder. Once a mixture of these powders is ignited, an exothermic reaction proceeds that produces a molten metal. In the instance of a mixture of aluminum powder and copper oxide powder, the exothermic reaction produces molten copper. Suitable powders for producing weld metal materials may be obtained from ERICO International Corporation of Solon, Ohio, USA. Further information on such powder materials may be obtained at www.erico.com.

With reference now in addition to FIGS. 2 and 3, details of the copper sheet 24 and its coupling to the wire 14 are discussed. The metal sheet 24 includes a main body 30 with a rectangular upper part 32 and a circular lower part 34. Extending out from one side of the circular part 34 is a radial extension 38. The radial extension 38 has a proximal wing 40 and a distal wing 42 extending therefrom. Bottom ends of the wings 40 and 42 may be approximately even with a bottom end of the circular lower part 34. The wings 40 and 42 extend a substantially equal amount downward and upward from the radial extension 38. The wings 40 and 42 may extend substantially parallel to the rectangular upper part 32 of the sheet main body 30.

The copper sheet 24 may be made from a suitable piece of sheet copper. The sheet 24 may have a non-uniform thickness. The rectangular upper part 32 and a top half of the circular lower part 34 may constitute a relatively thick portion 50 of the copper or metal sheet 24. The remainder of the sheet 24 (the other half of the circular lower part 34, the radial extension 38, and the wings 40 and 42) constitutes a relatively thin portion 52 of the copper sheet 24. The variable thickness copper sheet 24 may be formed by a suitable process, such as stamping. In an example embodiment the relatively thick portion 50 may have the thickness of 0.080 inches, and the relatively thin portion 52 may have a thickness of 0.062 inches. For a 25-gram exothermic weld bond, a copper thickness of 0.062 inches has been determined to be a suitable compromise between the desirable reduction in the size and depth of a heat affected zone in the steel rail material, and the advantageous maintaining of adequate mechanical strength of the resulting rail bond 12. It will be appreciated that other suitable thicknesses may be employed.

The thick portion 50 and the thin portion 52 are configured such that the thick portion 50 corresponds to areas of direct, primary, or initial contact by the liquid copper weld metal material. In such areas a greater thickness of the copper sheet 24 is required to control the heat affected zone (HAZ) in the underlying steel of the rail 16.

It will be appreciated that the configurations of the relatively thick portion 50 and the relatively thin portion 52 may be varied, for instance depending upon the shape of the copper sheet 24 and where the liquid weld material is to impinge. As a further alternative, it will be appreciated that the copper sheet 24 may have a uniform thickness.

The overall dimensions of the main body 30 may be approximately 0.88×1.28 inches. The radial extension 38 may have a length of about 0.56 inches, and the extensions 40 and 42 may each have a length of about 1 inch. It will be appreciated that the above dimensions are only those for a single specific example embodiment, and that many variations are possible in the size and the shape of the copper sheet 24.

The wings 40 and 42 are used to clamp the copper sheet 24 to the wire 14. As seen best in FIG. 3, the wings 40 and 42 wrap around and are crimped against the wire, cable, or rod 14. This is done so as to place an end 56 of the wire 14 in the middle of the circular part 34 of the copper sheet 24. The secure clamping of the wire 14 against the copper sheet 24 may deform the cross-section shape of the end 56 of the wire 14, flattening it against the copper sheet 24. The wings 40 and 42 may be bent and crimped against the wire 14 by hand, or through use of a suitable tool.

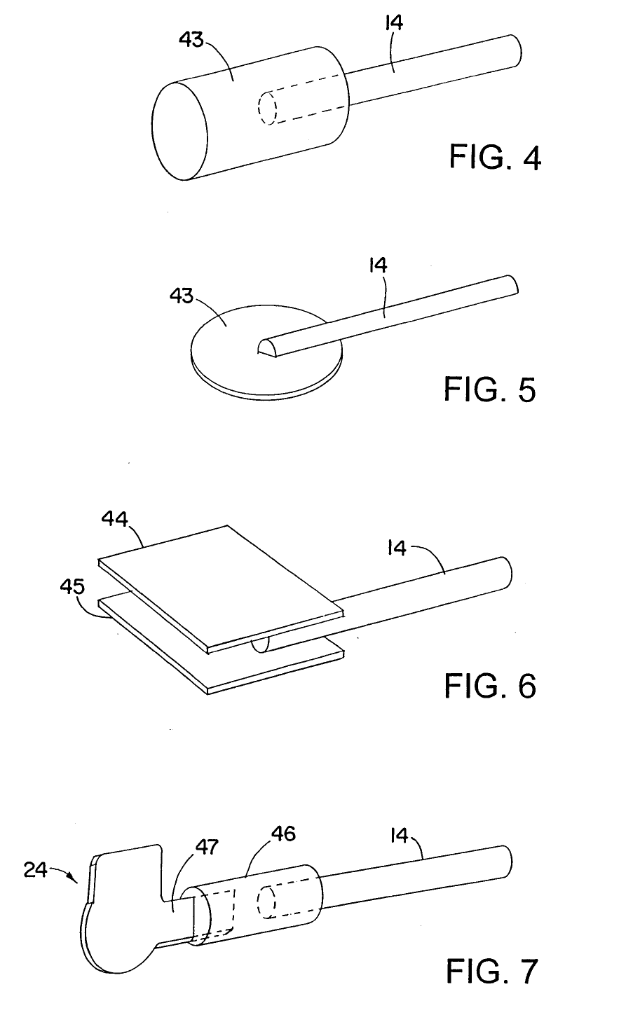

An alternative to using the wings 40 and 42 is to provide the copper sheet 24 is to insert the wire or cable 14 into a copper sleeve or tube 43, as shown in FIG. 4. The tube 43 can be flattened around the end of the cable 14 and cut to the appropriate shape, as shown in FIG. 5, to form a copper sheet. As shown in FIG. 6, another alternative would be to insert the wire or cable between two thinner metal sheets 44 and 45. The thin sheets 44 and 45 may also be flattened around the end of the cable and cut to the appropriate shape. Another alternative, shown in FIG. 7, is to crimp a sleeve 46 onto both the conductor 14 and an extension 47 of the metal sheet 24. Another possibility is attaching the wire or cable 14 to the copper sheet 24 by use of suitable welding processes such as ultrasonic welding.

In use the copper sheet 24 provides a barrier between the molten weld metal material and the rail to be bonded to. The copper sheet 24 absorbs heat energy from the molten weld metal, ultimately melting the copper sheet 24. Thus the copper sheet 24 operates as a heat sink with regard to heat from the molten weld metal. The copper sheet 24 then re-solidifies with the rest of the liquid copper (from the reaction of the granular weld metal material). This reduces the amount of heating occurring in the portion of the steel rail 16 underlying the copper sheet 24.

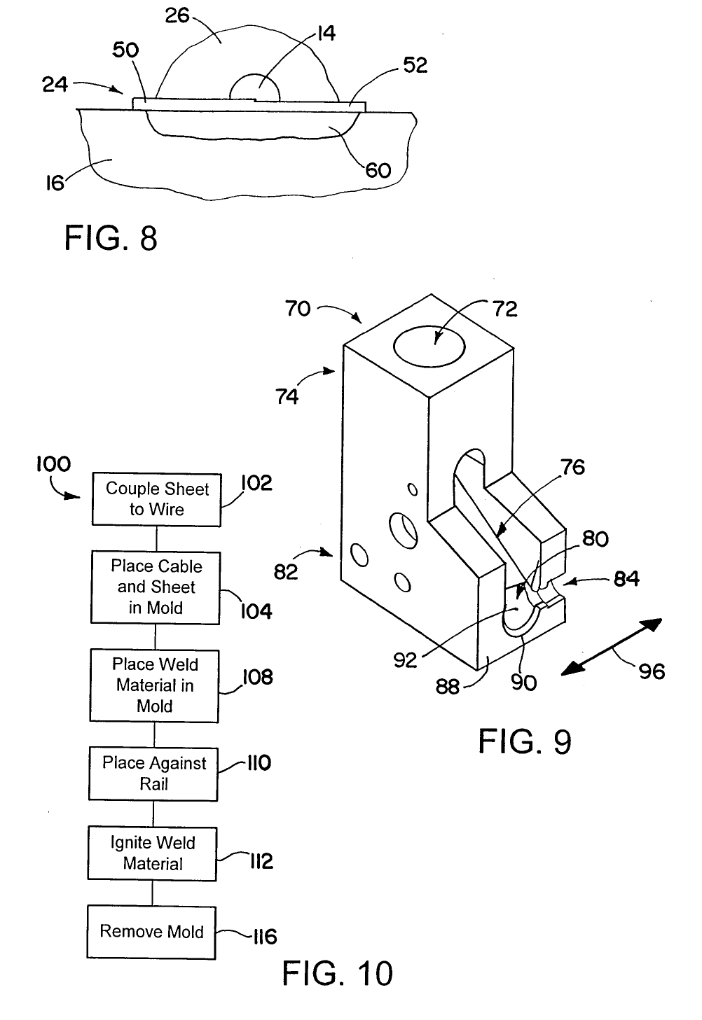

As illustrated schematically in FIG. 8, heating from the formation of the rail bond produces a heat affected zone (HAZ) 60 in which significant heating of the steel of the rail 16 occurs. It is desirable that the HAZ 60 be minimized in extent, in order to minimize changes to the structure of the heated steel. High temperatures produced in superheated liquid copper from the exothermic weld material reaction, which may be in excess of 2500° F., can produce localized regions of phase transformation in the rail steel under the exothermic weld. Standard steel used in making rails has approximately 0.80% carbon. In such steel a phase change occurs between approximately 1330 and 1400° F., at which the original pearlite microstructure of the steel transforms to austenite. Due to the large mass of the rail 16 and the extremely localized heat energy, this weld region cools rapidly. This transforms the austenite to layers of martensite, bainite, and pearlite, in successive layers under the bond 12. Such transformations are a characteristic of rails that are made of medium-or high-carbon steels (greater than 0.3% carbon).

Variable thickness for the copper sheet 24 may be used to make the heat affected zone 60 more uniform. The thicker portion 50 of the sheet 24 is placed at the location where greater thermal effects would occur if the thicker sheet were not interposed.

FIG. 9 shows a mold 70 used to produce the molten weld metal. The mold 70 has a top opening 72 through which the particulate weld-metal-producing powders are inserted and ignited. The exothermic reaction occurs in a chamber within a top portion 74 of the mold 70. A metal disk at the bottom of the chamber in the top portion 74 may be used to contain the powders prior to and during the initial phases of their exothermic reaction. This metal disk is eventually melted by the molten weld metal material, allowing the molten weld metal to pass into a chute 76. Details regarding the exothermic reaction that occurs in the top portion 74 may be found in U.S. Pat. No. 6,703,578, the drawings and detailed description of which are herein incorporated by reference.

The molten weld metal flows through the chute 76 and into a ball-shape chamber 80 in a bottom portion 82 of the mold 70. An opening 84 at one side of the ball-shape chamber 80 allows insertion of the wire 14 (FIG. 1) into the chamber 80.

The chamber 80 is open along a bond surface 88 of the mold 70. The bond surface 88 is the surface that is pressed up against the rail 16 at the location where the rail bond 12 is formed. The bond surface 88 has a chamfer 90 that is around a chamber opening 92 in communication with the chamber 80. The chamfer 90 has a shape corresponding to the shape of the main body 30 of the copper sheet 24. The chamfer 90 may be sized so that when the copper sheet 24 is inserted into the chamfer 90, the main body 30 and the bond surface 88 together form a substantially flat surface for pressing up against the rail 16.

The mold 70 may be made of a suitable refractory material, for example graphite. Graphite used in making the mold 70 may be extruded graphite.

The mold 70 that is shown is a right-hand mold. It will be appreciated that left-hand mold may also be employed to create rail bonds with an opposite orientation. The geometry of the copper sheet 24 (FIG. 2) is non-symmetric; however, the shape of the copper sheet may be made symmetric such that the same rail bond may be used with both right-hand molds and left-hand molds.

FIG. 10 shows steps of a method 100 for forming the rail bond 12 (FIG. 1). In step 102 the wings 40 and 42 of the copper sheet 24 are crimped around the wire or cable 14, to produce the mechanical combination shown in FIG. 3. In step 104 the combination of the wire 14 and the sheet 24 are put into position in the mold 70 (FIG. 9). The sheet 24 is placed within the chamfer 90 in the bond surface 88 of the mold 70. The attached wire or cable 14 passes through the wire opening 84 of the mold 70, and into the ball-shape chamber 80.

In step 108 the particulate weld metal material is placed into the mold 70. As discussed above, the particulate weld metal material is placed through the top opening 72 after a metal disk has been put at the bottom of the metal-forming chamber in the top portion 74 of the mold 70. As an alternative to using loose particulate weld metal material, it will be appreciated that the granular weld metal material may be placed in loose form, or may be enclosed in a suitable container or cartridge.

In step 110 the bond surface 88 and the copper sheet 24 are placed against the rail 16 at the location where the rail bond 12 is to be formed. Then, in step 112, the particulate weld metal material is ignited. Ignition may be by a spark, by an electrical igniter, or by any other suitable igniting device. The ignition causes the exothermic reaction in the particulate weld metal materials to proceed, forming the liquid copper weld metal. As discussed above, the weld metal breaks through the metal disk at the bottom of the top portion chamber and the mold 70, and proceeds through the chute 76 into the ball-shaped chamber 80. The heat from the liquid copper weld material causes melting of the copper sheet 24, which in turn causes heating in the heat affected zone 60 of the rail 16. The copper material then re-solidifies to form the rail bond 12, securely bonding the wire or cable 14 to the rail 16. After re-solidification, the mold 70 may be removed in step 116. The result is a secure long lasting rail bond 12 that reduces thermal effects on the material of the rail being bonded to.

It will be appreciated that the system and method described above may be more widely employed to couple items to metal objects other than rail bonds. The principle of using a metal sheet material to interpose between a liquid metal and an object to be bonded to may be used in bonding onto other types of objects.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A rail bond comprises:
a conductor cable;
weld metal connected to the conductor cable, wire, or rod; and
a metal sheet attached to the conductor cable, wire, or rod.

2. The rail bond of claim 1, wherein the metal sheet has a non-uniform thickness.

3. The rail bond of claim 1, wherein the metal sheet is a copper sheet.

4. The rail bond of claim 1, wherein the metal sheet is between the conductor cable, wire, or rod, and a rail upon which the rail bond is formed.

5. A method of bonding on a rail, the method comprising:
placing a metal sheet against the rail;
bringing molten weld metal material into contact with the metal sheet, thereby causing the metal sheet to melt and bond with the rail.

6. The method of claim 5, wherein the bringing includes bringing the molten weld metal material in contact with a cable, wire, or rod to be bonded to the rail.

7. The method of claim 6, wherein the molten weld metal material is in a chamber in a mold when brought into contact with the metal sheet and the cable, wire, or rod.

8. The method of claim 5, further comprising, before the bringing, placing the sheet and the cable, wire, or rod into the mold, adjacent to a chamber in the mold.

9. The method of claim 8, wherein the placing the sheet and the cable, wire, or rod into the mold, includes placing part of the sheet into a chamfer in the mold.

10. The method of claim 5, wherein the metal sheet is a copper sheet.

11. The method of claim 5, further comprising attaching the metal sheet to a cable to be bonded to the rail.

12. The method of claim 11, wherein the attaching occurs before the placing and the bringing.

13. The method of claim 5, wherein the metal sheet has a non-uniform thickness, with a thicker portion and a thinner portion.

14. The method of claim 13, wherein the bringing includes bringing the molten weld metal material into contact with the thicker portion first, before the molten weld metal material contacts the thinner portion.

15. A method of bonding on a rail, the method comprising:
placing a cable, wire, or rod into a chamber of a mold;
placing a metal sheet in an opening in the mold, adjacent to the chamber;
placing the mold against the rail, with the metal sheet between the rail and the cable, wire, or rod; and
directing molten metal material into the chamber, thereby causing the metal sheet to melt and bond with the rail.

16. The method of claim 15,
wherein the metal sheet has a non-uniform thickness, with a thicker portion and a thinner portion; and
wherein the directing includes bringing the molten weld metal material into contact with the thicker portion first, before the molten weld metal material contacts the thinner portion.

17. The method of claim 15, wherein the placing the sheet includes placing part of the sheet into a chamfer in the mold.

18. The method of claim 15, wherein the metal sheet is a copper sheet.

19. The method of claim 15, further comprising attaching the metal sheet to a cable to be bonded to the rail, prior to the placing the mold against the rail.
